(19) United States
(12) Patent Application Publication
(10) Pub. No.: US 2017/0068416 A1
(43) Pub. Date: Mar. 9, 2017

(54) Systems And Methods for Gesture Input

(71) Applicant: Chian Chiu Li, Fremont, CA (US)

(72) Inventor: Chian Chiu Li, Fremont, CA (US)

(21) Appl. No.: 15/259,061

(22) Filed: Sep. 8, 2016

Related U.S. Application Data
(60) Provisional application No. 62/215,166, filed on Sep. 8, 2015.

(51) Int. Cl. G06F 3/0481; G06F 3/0484; G06F 3/0488

(52) U.S. Cl. CPC G06F 3/04812; G06F 3/04883; G06F 3/04845; G06F 2203/04806; G06F 2203/04803

(57) ABSTRACT

Systems and methods for arranging gesture input. In an aspect, screen grid is configured object based. In another aspect, effective object area is enlarged on screen. In yet another aspect, finger or hand gestures are configured to perform click act and temporary icons are generated for performing left and right clicks. Furthermore, methods are introduced for turning on gesture sensor and starting gesture input session respectively.

### CROSS REFERENCE TO RELATED APPLICATION

This application claims the benefit under 35 U.S.C. Sec. 119 of provisional patent applications Ser. No. 62/215,166, filed Sep. 8, 2015.

### FEDERALLY SPONSORED RESEARCH

Not applicable

### SEQUENCE LISTING OR PROGRAM

Not applicable

### BACKGROUND

Field of Invention

This invention relates to user input using finger or hand gestures at an electronic device.

Description of Prior Art

A user may enter input at an electronic device via keyboard, computer mouse, touch pad, touch-sensitive screen or touch screen, or other hardware components. In some cases, however, these methods are inconvenient or unavailable. For instance, when a computer is mounted on a wall in a public area, there may be no keyboard, touch pad, or mouse provided; and it may be too high to reach. In such a case, gesture may be an effective way for user to interact with the device. In addition, a computer placed at a public venue may serve a few purposes only. For instance, users may mostly select an object on screen to access needed information, or turn a page and then select another object to get info. When the primary task is to reach on-screen object, a traditional fixed fine grid may become an issue, since moving cursor by tiny steps is not only unnecessary, but also slow.

Therefore, there exists a need for gesture input method and a need to improve screen grid setting, which may make it easy for user to select a graphic object on screen.

For some small-sized wearable or portable devices, a small touch screen may be the main user interface. Consequently, a graphic object, which has to be big enough for fingertip to select, may take a sizable space of the screen. Thus only a few objects may be arranged on display, even though users may want to have more on-screen objects for more functions and options.

Therefore, there exists a need to arrange more graphic objects on a small screen and to make the objects easily accessible by users.

Unlike computer mouse or touch pad, when gesture is used as an input method, often-used actions like click, drag, left click, and right click may not be easily carried out due to lack of mechanical assistance. On the other hand, a complicated gesture act may not help either, since it may confuse or even scare away users.

Therefore, there exists a need for a gesture input method which users may accept and use to implement certain actions.

“Graphic object”, “object”, “icon”, and “button” are used as graphic identifier on a display screen and the four may be treated equally in the following discussions. Sometimes, “button” also means a hard physical button arranged on a device body, which may be easily recognized. On-screen “graphic object”, “object”, “icon”, and “button” may be associated with an application, a computer file, a device function, or certain contents of computer information. As graphic entities on screen, they may be highlighted and activated by click act via computer mouse. When an object is highlighted, its appearance and/or appearance of the area surrounding it within a boundary may be arranged to change conspicuously. For instance, the color of object or its boundary line may become brighter. Highlighting may happen, for instance, when a cursor overlaps an object or moves into the boundary of an object. Clicking on a highlighted object, or tapping an object directly on a touch screen, may cause activation. Activating an object means a corresponding application may be launched, a file may be opened, or certain contents may be presented. An on-screen object provides an easy and convenient way to reach an application, file, webpage, or data. Normally, when they are visible on screen, it means they are accessible and executable.

### OBJECTS AND ADVANTAGES

Accordingly, several main objects and advantages of the present invention are:
a). to provide improved method and system for gesture input;
b). to provide such method and system which have object-based screen grid for easy access of object through gestures;
c). to provide such method and system which have automatic screen grid setting for easy access of object through gestures;
d). to provide such method and system which enlarge object boundary on screen for easy access through gestures;
e). to provide such method and system which utilize gesture to access small objects on a small screen;
f). to provide such method and system which enable functions of click, drag, left-click, and right-click via gestures;
g). to provide such method and system which arrange temporary icons around an object to offer more options; and
h). to provide such method and system which arrange simple methods to turn on gesture sensor and start gesture input session respectively.

Further objects and advantages will become apparent from a consideration of the drawings and ensuing description.

### SUMMARY

In accordance with the present invention, methods and systems are proposed for easy and convenient gesture input. Screen grid may be object based and adjusted automatically by position of graphic objects. Effective area of graphic object may be enlarged for easy access. Object-based grid and enlarged effective area may make gesture method more efficient and convenient. Gestures may be used to access small object on a small screen. Gestures may also be used to perform click act. Temporary icons may be arranged around a graphic object for functions like left click, right click, and drag. Simple methods may be used to turn on gesture sensor and start gesture input session respectively.

### DRAWING FIGURES

FIG. 1 shows a prior-art screen grid design.

FIG. 2 is an exemplary block diagram describing one embodiment in accordance with the present invention.

FIGS. 3-A and 3-B are exemplary diagrams showing embodiments of object-based grid in accordance with the present invention.

FIGS. 4-A and 4-B use exemplary diagrams to show enlarged boundary of on-screen object in accordance with the present invention.

FIGS. 5-A and 5-B are exemplary diagrams showing display of objects on a small screen and access of small object by gestures in accordance with the present invention.

FIGS. 6-A, 6-B, and 7 employ exemplary diagrams to illustrate proposed gesture instructions in accordance with the present invention.

FIGS. 8-A, 8-B, 8-C and 8-D display exemplary diagrams showing generation of temporary icons around a highlighted graphic object.

FIG. 9 shows an exemplary flow diagram of gesture input session in accordance with the present invention.

FIGS. 10 and 11 are schematic diagrams showing methods to turn on gesture sensor and request a gesture input session respectively.

FIG. 12 is an exemplary diagram showing temporary icons generated for on-screen object in accordance with the present invention.

FIG. 13 is an exemplary diagram showing embodiment of enlarging small objects on touch screen in accordance with the present invention.

FIGS. 14-A and 14-B are exemplary diagrams showing remote control of television via gestures in accordance with the present invention.

### REFERENCE NUMERALS IN DRAWINGS

| | | | |
|---|---|---|---|
| 10 | Grid | 12 | Grid |
| 14 | Screen | 16 | Screen |
| 18 | Object | 20 | Object |
| 22 | Object | 24 | Sensor |
| 26 | Sensor | 28 | Sensor |
| 30 | Processor | 32 | Computer Readable Medium |
| 34 | Screen | 36 | Device |
| 38 | Grid | 40 | Grid Point |
| 42 | Grid Point | 44 | Grid Point |
| 46 | Grid Point | 48 | Screen |
| 50 | Finger | 52 | Screen |
| 54 | Object | 56 | Object |
| 58 | Object | 60 | Screen |
| 62 | Object | 64 | Object |
| 66 | Object | 68 | Smartphone |
| 70 | Screen | 72 | Button |
| 74 | Button | 76 | Cursor |
| 78 | Boundary | | |

100, 102, 104, 106, and 108 are exemplary steps.

### DETAILED DESCRIPTION

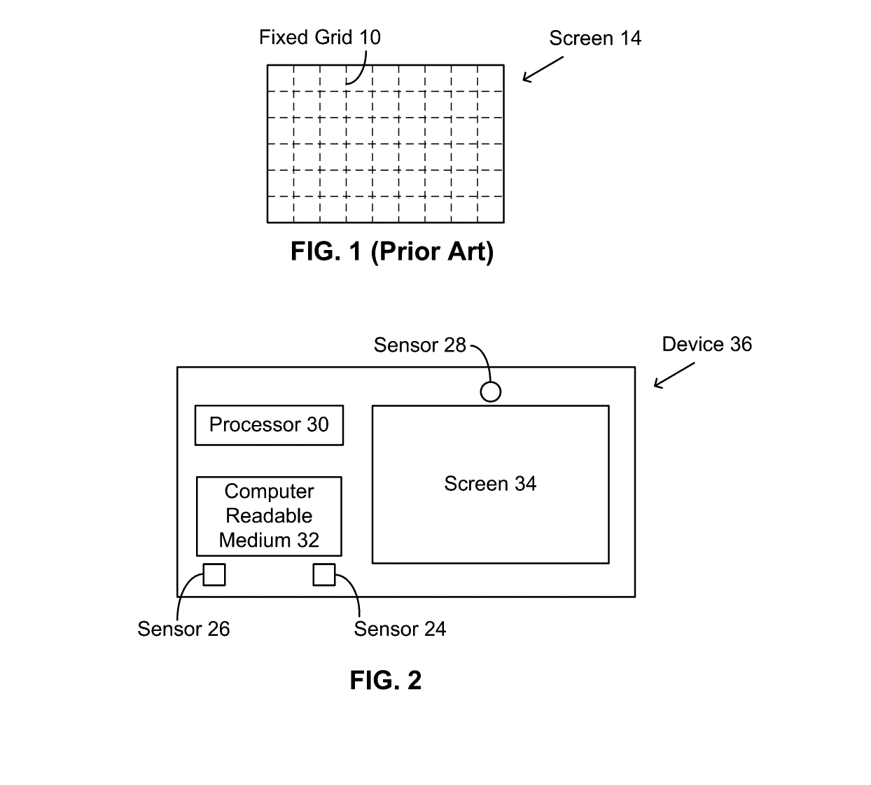

FIG. 1 shows a prior-art grid design. On a screen 14, there is a traditional grid 10 with fixed grid spacing which is designed to meet all needs. Resultantly, grid spacing is usually made as fine as it is allowed to accommodate tasks requiring tiny steps, e.g., a drawing work. Usually, a user won't adjust default grid setting, and grid setting would keep original values and stay unchanged.

FIG. 2 is an illustrative block diagram of one embodiment according to the present invention. A client device 36 may represent an electronic device, including but not limited to mobile phone, smart phone, smart watch, smart band, smart ring, other wearable devices, desktop computer, handheld computer, tablet computer, wall-mounted computer for public use, television, virtual reality (VR) device, augmented reality (AR) device, and the like. Device 36 may include a processor 30 and computer readable medium 32. Processor 30 may mean one or more processor chips or systems. Medium 32 may include a memory hierarchy built by one or more memory chips or storage modules like RAM, ROM, FLASH, magnetic, optical and/or thermal storage devices. Processor 30 may run programs or sets of executable instructions stored in medium 32 for performing various functions and tasks, e.g., surfing on the Internet, accessing website or online info, placing phone call, playing video or music, gaming, electronic payment, social networking, sending and receiving email, short message, file, and data, executing other applications, etc. Device 36 may also include input, output, and communication components, which may be individual modules or integrated with processor 30. The communication components may connect the device to another device or a communication network. Usually, Device 36 may have a display with, for example, a screen 34 and a graphical user interface (GUI). A display may have liquid crystal display (LCD) screen, organic light emitting diode (OLED) screen (including active matrix OLED (AMOLED) screen), or LED screen. A screen surface may be made sensitive to touches, i.e., sensitive to haptic and/or tactile contact with a user, especially in the case of smart phone, tablet computer, smart watch, smart ring, and other wearable devices. Touch screen may be used as a convenient tool for user to enter input and interact with a system. Furthermore, device 36 may also have a voice recognition component for receiving verbal command or audio input from a user. For VR and AR devices and some wearable devices, virtual screen or screen having a very small size may be arranged. While it may be impossible or inconvenient to tap an object on such a screen physically, input via verbal command and gesture instructions may become useful for users.

A communication network which device 36 may be connected to may cover a range of entities such as the Internet or the World Wide Web, a local area network (LAN), a wide area network (WAN), a metropolitan area network (MAN), a telephone network, an intranet, wireless, and other types of networks. Device 36 may be connected to a network by various wired, wireless, optical, infrared, ultrasonic or other communication means. Via a network, device 36 may communicate with a remote server or service center to send data, receive data and message, and follow up with instructions in the message.

Device 36 may include an optical sensor 28 which may be used as a video camera to detect user gestures using certain algorithm. Gestures may include finger or hand movement of user. For instance, sensor 28 may capture consecutive images. With certain algorithm, finger and hand may be recognized in the images. A series of finger and hand images may be collected and analyzed to identify certain moves against predetermined profiles. Then the moves may be interpreted as user commands for the device. Sensor 28 may be built using mature imaging technologies. For some smartphone and tablet computer, sensor 28 may be a front-facing camera module used by users in daily life.

Furthermore, sensor 28 may be used to track the eye of user via mature eye-tracking technologies. The sensor may be designed to sense the facial part of user and ascertain whether a user gazes at the screen 34. To facilitate the latter act, sensor 28 may be arranged very close to screen 34. Besides sensing a general direction, in a more advanced mode, the image of eye may be analyzed to determine where a user is looking at on a screen, places such as screen top, bottom, left edge, right edge, or a particular area, through algorithms. Both visible and infrared light may be employed for eye-tracking process. In the infrared case, specific light source may be arranged to provide a probing beam.

Device 36 may include a proximity sensor 26 to detect whether a device is close to human body or held in hand. Proximity sensing technologies are well known in the art and many smartphones have such a sensing function already. Related methods include infrared, capacitive, inductive, or other suitable technologies.

Moreover, device 36 may contain a motion sensor 24 to detect its own movement by sensing acceleration, deceleration, and rotation. Sensor 24 may employ one or multiple accelerometers and gyroscopes for performing various measurement tasks which may include detecting device shaking, device vibration, device moving of other kinds, and so on. These measurements help detect conditions and environment of user and device. They also make it possible to use shaking, knocking, waving, and other actions which cause a device to move in certain way to convey user instructions. Knocking may mean repeated gentle hits at a device body or screen. Knock may be applied by finger, fingertip, or any object which can cause a hit on a device. Knocking act is preferred to aim at a non-interactive area of device or at a place where it doesn't have unwanted consequences for application programs at a device. It is obvious that patting a device using hand or fingers is another kind of knocking. For simplicity reasons, most times knocking is mentioned in the following discussions, although both knocking and patting may produce the same effect or generate the same user command.

Inside device 36, output signals of sensors may be transmitted to processor 30, which, employed with proper algorithm, may process the data and send a message to a specific application arranged for handling it. The application may process the message and proceed accordingly, such as transferring certain data or instructions back to processor 30, sending messages to another sensor, or turning on a hibernating sensor or device.

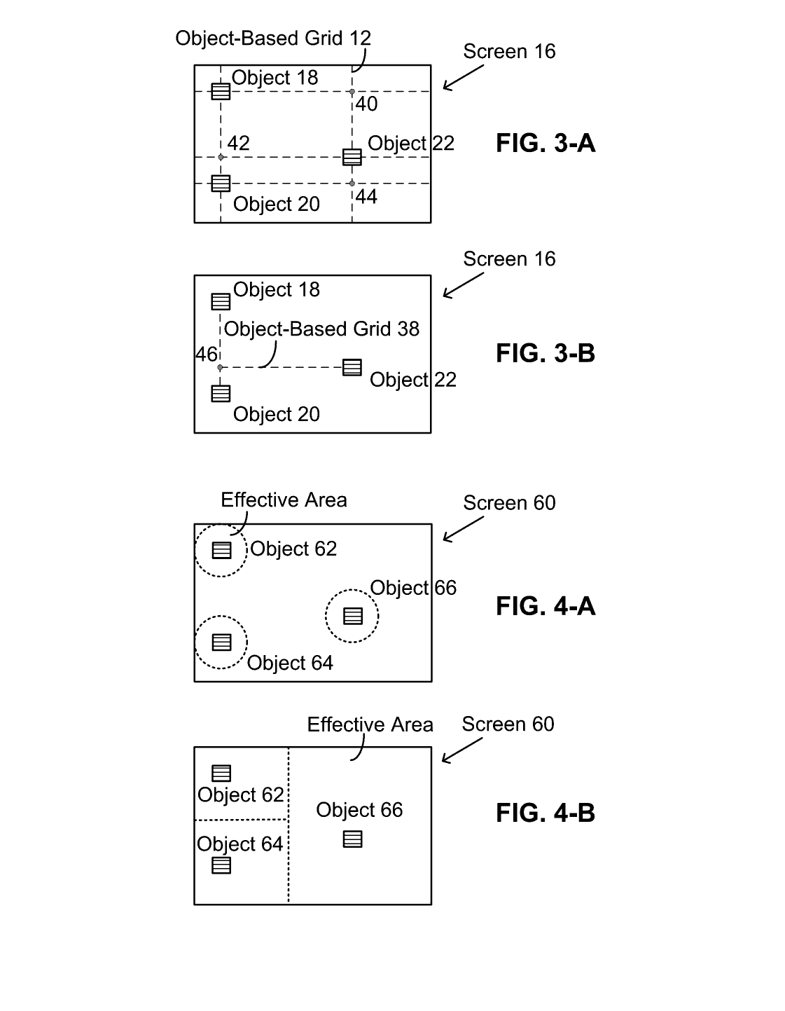

FIGS. 3-A and 3-B describe exemplarily two embodiments of object-based grid according to the invention. There are three graphic objects 18, 20, and 22 on a screen 16. Unlike fixed traditional grid, a grid 12 in FIG. 3-A may be arranged changeable and determined by position of on-screen objects. In other words, grid setting may be arranged depending on graphic object's position on screen and adjusted automatically according to change of object position. Hence, after an object is added on or removed from screen, grid configuration may be changed instantly by prearranged program. Automatic grid setting may be used for computers at public venue where seeking certain information is of the sole purpose.

Assume that a user is looking at a computer screen inside a museum. To get info, the user may move a cursor to highlight an object on screen and then click on it to open a content window. The main job here is to move a cursor to overlap an object. Thus moving it fast is of the top priority, while fine step resolution or grid resolution may become less important. Since reaching an object with one step is more convenient and efficient than doing it with several steps, a grid with large spacing may become desirable.

In the figures, every grid line goes through at least one object, either in vertical or horizontal direction. There are two vertical lines and three horizontal lines in FIG. 3-A, which creates six grid points, among which three points are taken by object. Grid point, as used in this discussion, means a point where two grid lines intercept or cross each other. Grid point may also be where a graphic object is positioned. Since there are six grid points in FIG. 3-A, there are only six places where a cursor may go or stay. For instance, if a cursor is at point 44, it is only one step away from object 22. And there is only one grid point between any two objects as shown in the figure. In addition, because there are only six grid points, or just six places for cursor to settle in, it becomes much simpler to direct a cursor to reach an object site than on a traditional grid where a cursor may stay at any spot on screen. Object site may mean an on-screen spot where an object is located. Once a cursor is moved to an object site, i.e., a grid point where an object is located, the cursor's image overlaps the object image. Then the object may change color as a way to show it is highlighted or selected.

In FIG. 3-B, objects 18, 20, and 22 remain at the same place on screen 16 as in FIG. 3-A. An exemplary grid 38, also based on object, is displayed schematically. Grid 38 is simpler than grid 12, since there are only two grid lines and four grid points, including three object sites, i.e., spots of three objects. There are one vertical grid line connecting objects 18 and 20, and one horizontal grid line connecting object 22 and grid point 46. Compared to six grid points of grid 12, grid 38 is further simplified with only four places for cursor to go. Thus, overlapping, highlighting, and activating an object may become more straightforward.

It is well known in the art about how to display a cursor on screen and how to move it around using computer mouse. There are programs available to create and control a cursor on screen. When finger or hand gestures are used, controlling a cursor may cause issues in some cases, since it may not be easy to make fine steps due to shaky hand in the air and inadequate detecting resolution. Thus, it may be difficult to direct a cursor stably and accurately on a fine grid using gesture commands. On the other hand, when the main purpose is to reach on-screen object, an object-based grid like grid 12 or 38 may become more effective as there are limited places for a cursor to go, there is no need to make tiny steps, and there is less trouble for a shaky hand. Therefore, when gesture input is used and the main task is to reach on-screen object, a grid that is based on object may be desirable.

Girds 12 and 38 may be called object-based grid and concise object-based types respectively. One difference between grid 12 and grid 38 is of grid point and grid line setting. For grid 12, a grid point is where two grid lines, horizontal and vertical ones, cross each other. So each grid point has two grid lines. For grid 38, a grid point may have either one grid line or two crossing horizontal and vertical grid lines. In the former case, a grid point may be an object site, while in the latter case, a grid point may or may not be an object site. Both grid 12 and grid 38 may share one feature: Each grid line always goes through at least one object site or each grid line is always controlled by position of one object. As a cursor only stays at grid point on screen, cursor position becomes always related to position of one on-screen object on an object-based grid. It may be designed that a user has options to select traditional grid type or one of the object-based grid types. For instance, an “Edit” button may be arranged on screen. Once in “Edit” mode, a user may select a grid type. When gesture method is used, it becomes quite likely an object-based grid is in need. Thus it may be arranged that a device may automatically change screen setting from a traditional to object-based grid type once a gesture session starts, and vice versa once a gesture session comes to an end. Automatic grid type switch may be arranged between a traditional grid and a chosen object-based grid type.

Object-based grid may be designed adjustable by change of object position on screen. In practice, a grid setting program may be created. Then, any appearance or disappearance of on-screen object may lead to change of grid configuration automatically. For instance, when an object is added between point 40 and object 22 on the vertical grid line in FIG. 3-A, a horizontal grid line may be generated accordingly by the grid setting program. The added grid line may produce two grid points. When an object is added between point 46 and object 22 Patent Application of Chian Chiu Li for Systems And Methods for Gesture Input. on the horizontal grid line in FIG. 3-B, a grid point may be generated at the new object's position. But no grid line is added. A new object may also be placed to a spot where no grid line goes through. Then the new object may trigger creation of one or two new grid lines besides a new grid point. Grid lines may be configured to be visible or to remain hidden. A grid setting program may also be arranged to provide options for user to choose visible or invisible grid lines.

FIGS. 4-A and 4-B show schematically another embodiment which illustrates methods for reaching on-screen object with ease and convenience. There are three objects 62, 64, and 66 on a display screen 60. An object may be reached or selected when a cursor overlaps its image or a cursor enters its boundary which encircles an area a little bigger than the image size. Usually, an overlapped or selected object may become highlighted visually on screen to show its status. When reaching on-screen object is of top task, an object's boundary may be enlarged substantially to make the job easier, as shown by the dotted circle lines in FIG. 4-A. Object's boundary may be expanded greatly to create a larger effective area in some cases. For instance, dimension of effective area in one direction may be increased by at least fifty percent or at least doubled. Increased effective area makes it much easier to reach an object. In the figure, size of object area is about doubled after enlargement, assuming that the original object area has a circle shape. The method applies to both fine and coarse grids. Enlarged effective area especially fits the need of gesture method, as a user may not be able to move a cursor agilely and accurately by finger or hand gestures.

FIG. 4-A represents symmetric boundary enlargement, i.e., enlargement is the same in all directions. Sometimes asymmetric enlargement is in need. For instance, when two objects are placed close to each other, there is little room for expanding boundary between them. In such a case, object boundary may be enlarged asymmetrically. It may be arranged that boundary remains the same at one direction but expanded at other directions or boundary is expanded less at one direction but more at another direction. Boundary may also be pushed to screen edges as shown in FIG. 4-B, where the dotted lines, which represent mutual boundary lines, divide screen 60 in three rectangular-shaped portions belonging to the three objects. It is noted that by such design, every spot on screen belongs to one object or is located in one object's effective area. Thus wherever a cursor goes, it is with an object or makes an object highlighted. A cursor may appear at certain distance away from an object on screen. However, as long as it is inside an object's effective area, the object becomes selected and highlighted. It makes it convenient to reach an object, suitable for cases where reaching an object is the major goal, and again especially suitable when gesture input is involved, since gesture provides coarse cursor control.

The dotted lines which define the effective object areas may be configured to show up or remain hidden. It may be arranged that a user may have options to choose a visible or invisible boundary line and switch between them. For instance, an “Edit” mode may be designed. A user may enter the mode and change settings like boundary line arrangement. A user may also have options to choose among regular effective area, expanded effective area, and maximum effective area. The former case represents current method with a basic effective area. In the second case, a user may have further options to select an enlargement factor or how much an effective area is enlarged. The latter case reflects what depicted in FIG. 4-B, where all screen space is used for effective object areas. Like object-based grid, enlarged effective object area may automatically replace regular effective area after a gesture session gets started, when a user selects certain options in “Edit” mode. An object may remain highlighted after a cursor enters its effective area and stays inside the area. Once highlighted, the whole expanded effective area may change color or brightness.

It is noted that principles of object-based grid is similar to maximum effective area shown in FIG. 4-B. Returning to FIG. 3-B for instance. There are four grid points in the figure. Each grid point has an effective grid area. At an object site, effective grid area and effective object area are the same. When a cursor enters a grid area, it reaches a grid point automatically. For object-based grid, a screen is divided by effective grid area. No matter where a cursor is, it is in one effective grid area. For instance, screen 16 is divided by four grid areas in FIG. 3-B, corresponding to four grid points. Boundary between grid point 46 and grid point of object 22 may be arranged by a vertical line going through the midpoint between them. Boundary between point 46 and object 18 may be a horizontal line at the midpoint between them. Thus effective grid areas may be created by boundary lines which go through midpoints. Resultantly, object 22 may have a single shared boundary line and the largest effective area which occupies about half of the screen space.

When a cursor enter a grid area, its image is placed at the grid point or arranged overlapping an object instantly, even though the cursor's actual position may be away from the grid point. In other words, when an object is highlighted, a cursor is always arranged overlapping it, since the cursor has to be at a grid point for object-based grid. Thus, when a user moves a cursor on an object-based grid, a control system may detect position of the cursor and determine which effective grid area it is in, and then place the cursor at a matching grid point. It may happen that a user tries to move a cursor, but the cursor still stays at the same place or same grid point as long as it hasn't entered another effective grid area. When gestures are used to move a cursor, a gesture sensor may measure where the cursor is moved to. If the cursor is still within the old effective grid area, cursor image on screen may stay put. If it is determined that the cursor enters another effective grid area, the cursor may be moved to grid point of that area.

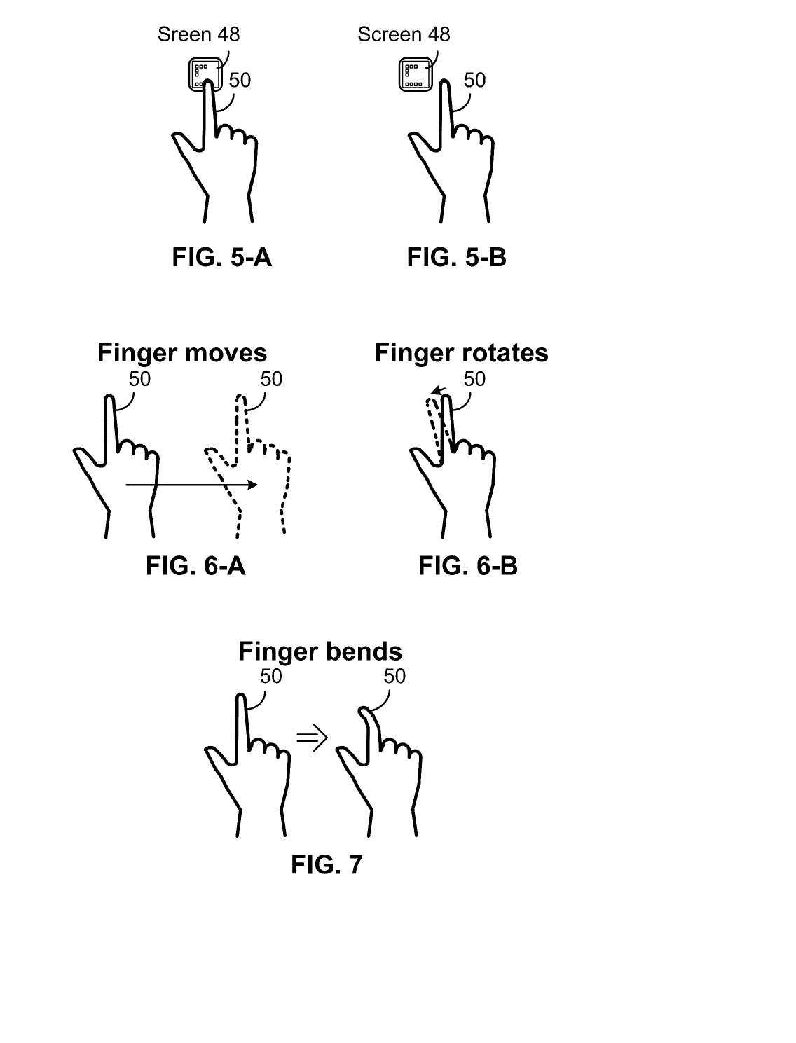

FIGS. 5-A and 5-B are exemplary diagrams showing an embodiment of gesture input for small-sized device. When a device is small, such as wearable or some portable device, its display screen is small. Limited screen size means only a few objects may be arranged to appear. When more objects are presented, object size has to be reduced. Assume that a screen involved is touch sensitive. When two objects are small and placed together on screen, a tap of fingertip may contact them simultaneously, or it may be difficult to pick one between them. As a consequence, only a few items may be displayed on screen, providing fewer options than needed. Such dilemma may be overcome by gesture method. As shown in the figures, a screen 48 may be arranged to show several tiny objects. The objects may be too small for a finger 50 to select individually, since a fingertip may tap two objects together as depicted graphically in FIG. 5-A. However, the issue may be resolved by gesture method which is schematically illustrated in FIG. 5-B, i.e., two closely positioned objects may be picked individually and easily by gestures. Finger 50 may move around in the air and choose one object on screen 48 at a time. First, a cursor may be arranged small enough to overlap one object individually. Second, it may be designed that cursor travelling distance is proportional to finger or hand travelling distance with a given ratio, larger or smaller than one in most cases. For instance, when finger 50 travels a certain distance, a corresponding cursor may move a fraction of the distance on a small screen, or move a longer distance for a large screen. In the figure, it may be arranged that when a fingertip moves ten millimeters in the air, a cursor may move only one millimeter on screen in the same or similar direction.

Thus a user may move a cursor with small step, make it overlap a small object, or direct it to travel from one small object to another one conveniently. Therefore, with gesture input, small objects may be placed on a small screen with tight spacing, while how to reach them is not a concern. For instance, object size may be smaller or much smaller than fingertip of adult user, or object dimension may be as small as two to seven millimeters or less, and the spacing between two objects may be configured to be as narrow as half millimeter or less. When a cursor overlaps an object, the object may become highlighted. Next, a gesture-based click act may be performed to activate the object or execute a task which is associated with the object. It is noted that object-based grid plus gesture method may work for small screen as well.

FIGS. 6-A, 6-B, and 7 describe exemplarily certain finger movement which may be used as gesture commands. For instance, fingertip of index finger 50 may be used as an input tool to direct cursor movement on screen. When a hand moves, finger 50 moves along, so does fingertip of finger 50. When user's hand remains in place but finger 50 rotates, the fingertip moves too. In both cases, the fingertip changes its position, while the hand may keep straight or maintains a relatively stable state, as illustrated graphically in FIGS. 6-A and 6-B. In both cases, movement of fingertip may be used to direct movement of cursor on screen with a predetermined ratio between distances travelled in the air and on screen. For instance, when a fingertip moves twenty millimeters horizontally to the right, a cursor may be configured to move two millimeters horizontally to the right. The situation may be arranged applicable at other directions. As discussed, a detector like sensor 28 of FIG. 2 may be arranged to capture a series of images of finger or hand consecutively and continuously. Images in sequence may be analyzed through specific algorithm to identify certain act performed by user and translate it into user instructions.

When a cursor moves on screen, it may highlight a graphic object when it overlaps the object. But a highlighted object doesn't get activated automatically. When the cursor is moved away from the object, highlight state may end and the object may returns to its original on-screen appearance. This is like using computer mouse to move a cursor, and makes an object highlighted.

Activating an object needs a click act. To implement it, a finger bending process is introduced graphically in FIG. 7, where finger 50 is used to release a click command. A program may be designed to handle gesture input. When the program gets info that a finger goes from straight to bent and then back to straight state within a given time period, it may take the movement as mouse click act and then send a message to device control unit. Then the device may know where on screen a click action happens. If an object is already highlighted by cursor overlap, device control unit may activate the object.

As user may have different finger bending habits, such as causing a finger to point to the right side, the left side, the forward direction, or the backward direction, finger images may have quite different profiles. Assume that an imager or video sensor is right in front of a user, or a user faces the sensor. In the former two scenarios, finger bending may feature a transition from a straight object to a bent object. The transition may be recorded and analyzed. For instance, sequential images taken by a sensor may be used to determine that a straight object bends gradually. On the other hand, for the latter two scenarios, finger bending may cause a transition from a straight object to a shortened straight object. In addition, there are cases in between the former two and latter two scenarios, where images may reflect both bending and shortening processes.

Doing finger bending act twice within certain time may be designed to work as double clicks, which may equal to the well-known double clicks using computer mouse. A double-click procedure may be used to perform a special task or implement a given function for some cases.

Consequently with a click act carried out by finger bending method, a highlighted object may be activated. The activation may open a file folder, launch a program, carry out a task or function, or start other activities. It may also be designed that when a finger bends and remains a bent state, it may work like pushing down a button of computer mouse without releasing it. Then it may be designed that a highlighted object may be dragged to move around on screen with a bent finger. For instance, when a user wants to move an object at a spot on-screen, the user may use a finger to direct a cursor, let the cursor overlap the object, making it highlighted, bend the finger, use the bent finger to drag the object around, and then straighten up the finger to place the object at another spot. Once a finger remains in bending state beyond a given time period or an object is moved by bent finger, straightening the finger may not cause a click act. So an object may be dragged on screen without activation concerns.

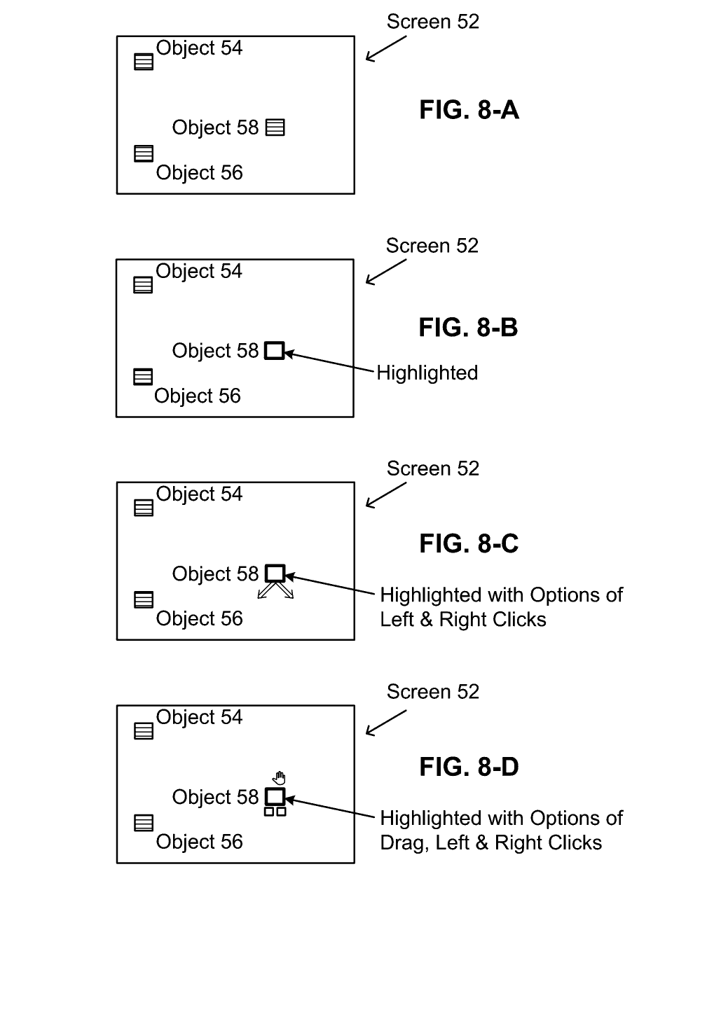

FIGS. 8-A, 8-B, 8-C, and 8-D are schematic diagrams depicting embodiments of gesture input method. As discussed, an act equivalent to mouse click may be performed by bending a finger and then re-straightening it. However, such a click is generally left-click and right-click may also be desirable in applications. Left and right clicks can be easily performed using computer mouse's left and right buttons separately. Special finger or hand gestures may be designed to do left and right clicks too, but the related gesturing process may be too much to learn and use for a lot of users. A method to deal with the issue is depicted in the figures schematically. In FIG. 8-A, a device screen 52 shows three objects 54, 56, and 58. Next in FIG. 8-B, object 58 is highlighted using gestures, e.g., by moving a cursor to overlap object 58. A highlighted object may show its status by change of appearance in terms of color or brightness. Although a highlighted object may be activated by finger-bending-and-straightening act, it may work as left click only, while right click is ignored this way.

In FIG. 8-C, it is designed that when object 58 has tasks associated with left and right clicks respectively, it shows two arrow icons once being highlighted. If a fingertip moves along the left arrow, then goes backwards to return to the object within a given period of time, like two or three seconds, it may construct a left click. When a fingertip moves following the right arrow and then gets back to the object in certain time, a right click may be implemented. FIG. 8-D shows another exemplary configuration. When object 58 is highlighted, three small icons may appear around it, with two rectangular icons beneath the object for left and right clicks and a hand-shaped icon above the object for dragging it. It may be designed that when the left rectangular icon is highlighted and then clicked, a left click is performed; when the right rectangular icon is highlighted and then clicked, a right click is done. A click may be accomplished by the finger bending process discussed in the above. The three icons are temporary icons. They show up when an object is highlighted and stay there when highlight state continues or disappear automatically when click is not received within a given time period. So, a user may move a cursor to highlight an object via finger gesture, cause temporary icons to show up, let the cursor go further to overlap a temporary icon, optionally making the icon highlighted, and then click on an icon below the object to do a left or right click.

Hand-shaped temporary icon may be used to drag object 58 around. A user may use a fingertip to make a cursor overlap a hand-shaped icon and make it highlighted. Next the user may move the fingertip around on screen. The fingertip in turn moves the cursor which drags the object. After the object arrives at a spot, the user may click on the hand-shaped icon through the finger-bending method to end the drag process. Then it may return to the state in which object 58 is highlighted along with three temporary icons, if the fingertip goes back to overlap object 58. The highlight state may come to an end when a cursor moves out of the boundary of object 58. When an object is no longer highlighted, its temporary icons may be removed from the screen.

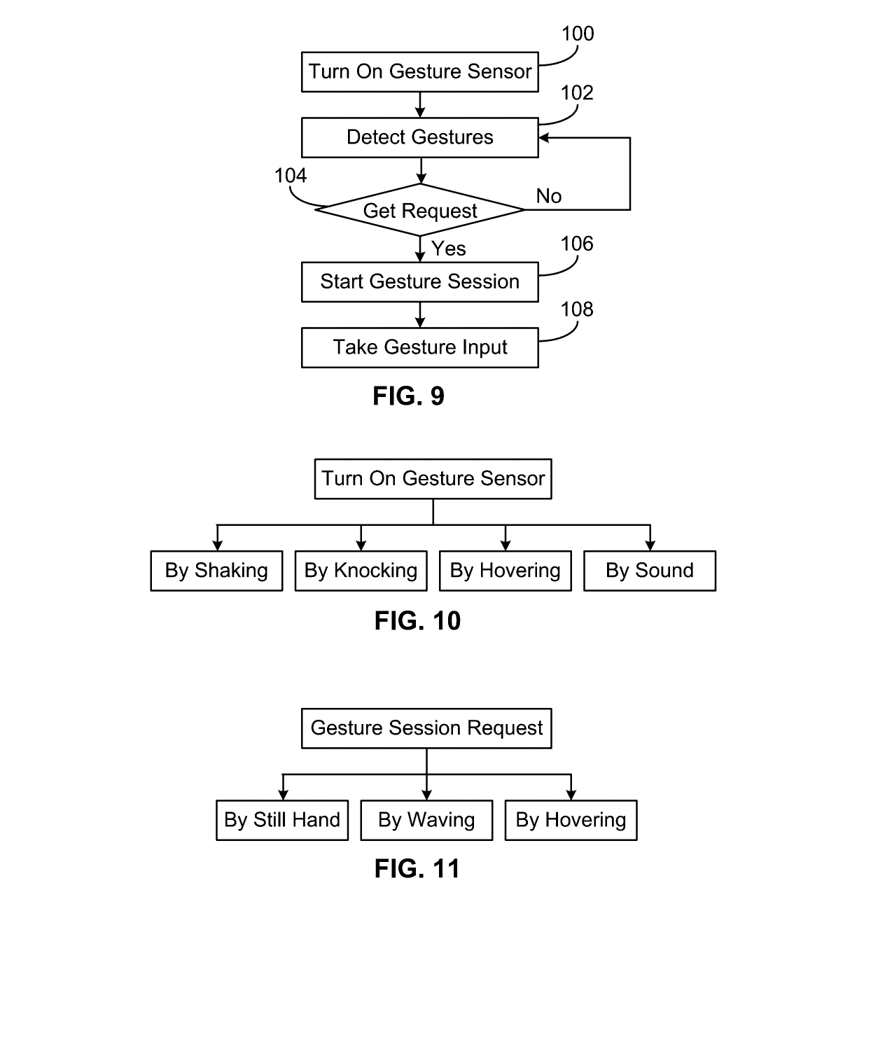

FIG. 9 is a schematic flow diagram to describe a gesture input session. In Step 100, a user switches on a gesture sensor. A gesture sensor may mean a detecting system which is arranged to acquire, analyze, and interpret user gestures. The sensor may be in an always-on mode, or turned on by various means and methods. Next in Step 102, the sensor may start a detecting process to search for gesture session request generated by user. In Step 104, a detecting result is made in a certain time frame. If the result is negative, meaning there is no request for gesture session, it may return to Step 102 and continue to detect gesture signals. If the result is positive, the sensor may start a gesture session in Step 106. A request for gesture session may be made using certain finger or hand gestures, or other methods. Finally in Step 108, the sensor may take gestures from user and translate them into user instructions.

As said, a gesture sensor may be in operational mode all the time, or turned on by user when there is a need. The former provides convenience to enter a gesture session, while the latter may save energy and reduce privacy concerns. When a sensor is off, it requires a wakeup signal to get activated. A sensor may be switched on via several methods as shown exemplarily in FIG. 10. For a device, it may be designed that a user may turn on a gesture sensor via several acts, such as shaking the device, gently knocking or tapping the device, finger or hand hovering over a touch screen, making a specific sound like clapping, or speaking to it. Details of each method will be discussed in below.

When a gesture sensor is on, a user may generate certain gesture to begin an input session. A request may be made by hand or finger act in a convenient and easy way. FIG. 11 lists some schemes. A request may be made by holding a still hand in the air or sticking out one or more still fingers in the air, or waving hand or finger. A request may also be made by finger hovering over a touch screen. It is noted that a hovering finger may be arranged to wake up a gesture sensor and start a gesture session at the same time. Once it is detected that finger hovering happens above device screen, a signal may be generated to turn on a gesture sensor. Since a finger is already positioned near the screen, it may confirm a user's intention to interact with the device, likely via gesture method. Then, a gesture session may be arranged to start while a sensor begins working. It is of hover-to-gesture-session scheme. Again, details of each method will be illustrated in below.

When a finger hovers over a touch screen, its fingertip may be kept close to the screen surface without contacting it. Hovering may be detected by mature technologies well-known in the art. Hovering act may be performed using other part of finger, like a knuckle or other part of hand. During a hovering event, a user may maintain a small spacing between screen surface and a fingertip or another part of hand. The spacing may be between one to seven millimeters or have a value below or beyond the range, as long as it can be detected that an object appears above a screen or close to a screen spot. Hovering also means an object stays around a hovering spot beyond a given period of time like one or two seconds, which is arranged to exclude other activities around a screen surface. It is noted that when a screen is in a horizontal plane, hovering may mean staying above a screen surface. When a screen is tilted at an angle relative to a horizontal plane, hovering may mean staying close to screen surface. In a hovering event, a fingertip or another part of hand may touch a screen surface slightly, if the touch doesn't cause any effect.

The following discusses two schemes to request a gesture session which are listed in FIG. 11.

Assume that a gesture sensor is already on. A gesture session may get started after a session request is received from a user. A session request may be made by user via holding a still hand or sticking out one or more fingers in the air. It may be arranged that when a user holds his or her hand still in the air and keeps it upright with palm facing any direction for certain time, or keeps one or more fingers stuck out in the air for certain time, it represents a request to start a gesture input session. For instance, once a device's sensor gets images of still hand or finger and gets them for a given period of time, the device may start a gesture session. It may be arranged that fingertip of index finger may be designated to lead cursor movement on screen, when index finger and other fingers show up. At the start, a cursor may appear at a certain place, such as the central area of a display screen. Then the cursor may move following movement of user's hand or fingertip.

A gesture session request may also be made by waving hand or waving finger in the air in front of a device. Assume that a cycle means moving a hand or finger and then moving it back close to the starting place or moving a hand or finger in one direction and then moving it back in the opposite direction. After a cycle, a hand or finger may return to the starting place or get close to the starting place. It may be designed that one or more cycles may construct a waving act. As waving hand is often used to get attention of the other party, it may become an easy and natural start of gesture process. For instance, a user may keep waving hand or finger until a cursor appears at certain part like a central area of device screen. Next the user may stop waving and hold hand or finger still in the air. Then, the user may move the cursor around on screen with hand or finger, followed by highlighting an object, opening an object, or executing an object by gesture instructions.

Once a session request is received, a sensor may start taking gestures as instructions from user. To avoid launching a gesture session accidentally due to inadvertent hand or finger movement, eye-tracking technology may be enlisted to confirm user's intention. For instance, it may be designed that after gesture signals are received and they mean to launch a gesture session, the signals may prompt start of eye-tracking procedures. When it is detected that a user gazes at a target device or along a direction toward the device for a given time, a gesture input session may begin. But if it is detected that the user does not gaze at the device for certain time, the session request which is received shortly ago may be discarded.

The following illustrates schemes to turn on a gesture sensor as introduced in FIG. 10.

As discussed, shaking act may be used to switch on a gesture sensor. A shaking act may be recognized by motion sensor like sensor 24 of FIG. 2. Not every shaking event may qualify as a turn-on signal. A shaking process, featured by profile of back-and-forth movement, has to last more than a given time but less than another given time. The first condition is meant to confirm that a user shakes a device on purpose. The second condition is used to exclude other shaking phenomena like shaking caused by a boat or vehicle, which may last a while. It may be designed that when a device experiences shaking for certain time, like within certain time range, it may trigger a gesture sensor. Optionally, a gaze sensor may be employed to detect whether a user gazes at the device to confirm his or her intention.

For devices of all sizes, like smartphone, wearable or portable gadget, and big screen television, a gesture sensor may be switched on when a user gently knocks or taps the body of device. A detector like sensor 24 of FIG. 2 may be arranged to recognize knock or tap acts which causes another kind of shaking event. It may be designed that knocking or tapping should happen at least two times but less than, for instance, five times. Knocking too many times may mean something else happens. After knock or tap signals are received, the device may wake up a gesture detecting sensor. Then a user may make gestures to request for gesture session, like holding a hand upright until a cursor appears. Next, a user may move the cursor to a target icon, “click” on it using finger-bending method, move the cursor to another spot, and so on.

A gesture sensor may also be turned on by hovering act. When it is detected that an object, including finger, hand, pen, or other object, hovers close to a touch screen for a given period of time, a gesture sensor may turn on and a gesture session may start with an emerging cursor or icon on screen at the same time. Then a user may either skip a gesture session by tapping on a screen or gesture in front of the screen to give instructions remotely. For instance, when a fingertip hovers close to a touch screen for a time period beyond a certain value, the device may follow a program to start a gesture sensor and a gesture session at the same time. Consequently, the device may become ready to receive gesture instructions as well as taps on the screen. A user may either tap an object directly on the screen, or move a fingertip in the air to perform a gesture-based click. It may be designed that after a hovering act triggers a gesture session, a cursor may appear at a screen spot close to the hovering fingertip or hovering object. Next the cursor may be moved around on screen by fingertip or hand. The ratio between a distance a fingertip travels in the air and a distance a cursor moves along the same direction on screen may be predefined and remain adjustable by user. For a small screen, the ratio value may be arranged larger or much larger than one to accommodate comfortable controlling needs. For a big screen, the ratio may be small than one.

Method of hover-to-gesture-session like just discussed is in particular helpful for devices with a small screen size, as objects on a small screen may be small and thus there may be difficulties when tapping has to be performed. Gesture input gives user an alternative means, when tapping becomes hard to do in some cases. On the other hand, for devices with not-so-small touch screen, such as smartphone and tablet computer, having one more input option is also helpful. For instance, when a finger is near a touch screen, it helps when both tapping and finger gesturing work. As a user may either touch a screen or keep a distance from the screen when interacting with the device, which may create comfort, ease, and certain freedom. During hovering, a fingertip may be out of the field of view for a gesture sensor, since a sensor and screen surface may be arranged in the same plane. For instance, smartphone, tablet computer, and certain wearable devices may have such configuration. Thus it may become difficult for a gesture sensor to detect fingertip and its movement when the fingertip is close to screen surface. In such cases, a user may move a hovering finger away from the screen and into the sensor's field of view if the user wants to use gesture method.

Back to discussions about how to turn on a gesture sensor. A sensor may also be waked up by certain sound like user's voice command or some special but easy to make sound. Voice recognition technology is mature and may be incorporated with gesture method to make it easy and convenient for some users. For instance, assume a voice recognition system is on. A user may say “Gesture” to turn on a gesture sensor. After that, the user may gesture for session request, such as waving hand to bring a cursor on screen, get the cursor to overlap an object, execute an application associated with the object, and so forth. A gesture sensor may also be turned on when hand clapping sound, a whistle, or knocking sound is received. Sound method may be combined with eye-tracking scheme too. For instance, after a device receives verbal command “Gesture”, it may open a sensor to check gaze direction of user. If the user gazes at the device or screen, it may confirm that the user wants to do gesture input. Then the device may turn on a gesture sensor and prepare to take and analyze gestures the user may make. If the user gazes at a direction toward another place, the verbal input may be ignored while the gesture sensor may remain in down or sleeping state.

When a gesture sensor is waked up, a device may have a screen in active or inactive mode. An inactive mode may mean a dark screen or a screen with screen-saver program. It may be arranged that an inactive screen may not be affected by wake-up event of gesture sensor. For instance, a dark screen may remain dark until receiving a gesture session request from user. Once a session request is received, an icon like a cursor may appear on screen. After a user moves a cursor on screen, a dark screen may turn bright to show an interface which may be the one before the screen went dark, a screen view of locked state, or a screen view of another prearranged program.

In above discussions, a fingertip may be arranged to direct cursor movement on screen. For instance, when a user sticks out a finger to request for gesture session, the finger's tip may be observed and its move in the air leads to corresponding move of cursor on screen. When a user holds a still hand with spreading fingers to request a gesture session, fingertip of index finger may be used as an indicator to direct cursor movement. A gesture session may start with appearance of cursor image on screen.

In some applications, a task may involve selecting and activating an on-screen object, which may be accomplished using cursor and aforementioned gesture instructions. In other applications, what in need may be scrolling a screen view up or down, moving it toward the right-hand side or left-hand side, or sliding it to turn a page. Using cursor to implement such act is doable but may not be that convenient. Thus, it may be designed that when one or two fingers stick out, it may mean a user wants to use a cursor. Then a finger tip is locked to lead cursor movement. When three or more fingers stick out including a still hand with spreading fingers, it may mean a user wants to move screen view or screen page. If the fingers move from a spot to the right, the screen page may be dragged to the right. If fingers or hand moves to the right then moves back to the left, the screen page may be dragged to the right and then dragged back to left. Similarly, a screen page may be dragged upwards or downwards. When a screen page is dragged away from its original position, another screen page may be arranged to fill the void. When a new screen page is totally moved in, the new page stays and a page is turned. Thus, a user may turn a page by moving stuck-out fingers to the right or left until a new page occupies the whole screen. To continue reading, a user may put stuck-out fingers back to a place, and then make another move to turn another page. After a page is turned, a user may have to move a gesturing hand to a place for another action. For instance, after sliding fingers for a distance towards the left direction, a page is turned. Next a user may move the fingers back and let them stay in the air for at least a given time, which may mean the user is ready for another page-turning action. Then the user may slide fingers to the left or right to turn a page forward or backward, which is unrelated the previous move.

When a cursor appears on screen, it may be called cursor mode. When a screen page moves around with fingers, it may be called page-moving mode. Cursor mode and page-moving mode may be arranged switchable. For instance, when one or two stuck-out fingers are detected, cursor mode gets started. Cursor moves following finger movement. When three or more stuck-out fingers are detected, page-moving mode takes place. Screen page moves following movement of the fingers. Mode switching may happen anytime as long as certain finger gesture is detected.

### Conclusion, Ramifications, and Scope

Thus it can be seen that systems and methods of gesture input are introduced and discussed.

The improved method and system have the following features and advantages:
(1). Screen grid may be made self-adjustable and object-based to make it easy and convenient to reach an object;
(2). Effective area may be enlarged to make it easy and convenient to reach an object;
(3). Gesture may be used to reach small-sized objects on a small screen;
(4). Finger and hand gestures may be designed to move cursor, perform click act, or move a screen page;
(5). Temporary icons may be arranged around an object for conducting left click, right click, and drag act;
(6). Gesture sensor may be turned on by shaking, knocking, hovering act, certain sound, and verbal instructions;
(7). Hand gestures and hovering act may be arranged to start a gesture session; and
(8). Hovering act may be arranged to switch on a gesture sensor and start a gesture session at the same time.

Although the description above contains many specificities, these should not be construed as limiting the scope of the invention but as merely providing illustrations of some of the presently preferred embodiments. Numerous modifications will be obvious to those skilled in the art.

### Ramifications:

Besides index finger as used in FIGS. 5-A, 5-B, 6-A, 6-B, and 7, other fingers may be used to do gesture input too. For instance, a user may stick out any finger and hold it still in the air. Next, the finger may be recognized, picked, and monitored. As in the above, such finger act may work as a request to start a gesture session. A user may also use the finger and its fingertip to direct a cursor on screen and perform other gesturing activities.

In FIG. 8-D, in cases when object 58 has no right-click function, it may be designed that only the hand-shaped icon shows up when the object is highlighted. In FIGS. 8-C and 8-D, when object 58 has right-click function, it may be designed that clicking on the object itself means left click. Thus in one configuration, the arrow or rectangular icon on the left side may be removed. When an object is highlighted, only a right arrow or right rectangular icon emerges below the object. It may simplify screen view.

Temporary icon method as discussed in FIGS. 8-C and 8-D may be applied to touch screen scenario too. Currently, when an object is tapped on screen, meaning the object is touched briefly, it is activated. When an object is pressed continuously beyond certain time, more options to deal with the object may show up if there is such arrangement. But pressing an object for a prolonged period of time may cause uneasiness and anxiety. It may be designed that when a fingertip hovers over an object for a given short period of time, say one or two seconds, the object may be highlighted. Once an object is highlighted, temporary icons, like arrows, rectangular or hand shapes, may show up around it for a given brief period of time. A user may tap a temporary icon to execute a task. Thus, these temporary icons may appear and work in the same way as that introduced in FIGS. 8-C and 8-D. Like in a gesture process, the same temporary icons may be arranged for an object: An icon for right click, which may be placed on the right-hand side beneath the object, assuming left click may be done by tapping the object directly; and an icon for dragging the object, which may be placed on top of the object. So, a user may conveniently highlight an object by finger hovering, and then tap to do left or right click, or drag the object to another place on screen. The hover-to-highlight scheme applies to devices with touch screen and hovering detection capability, including wearable devices, smartphones, tablet computers, and the like.

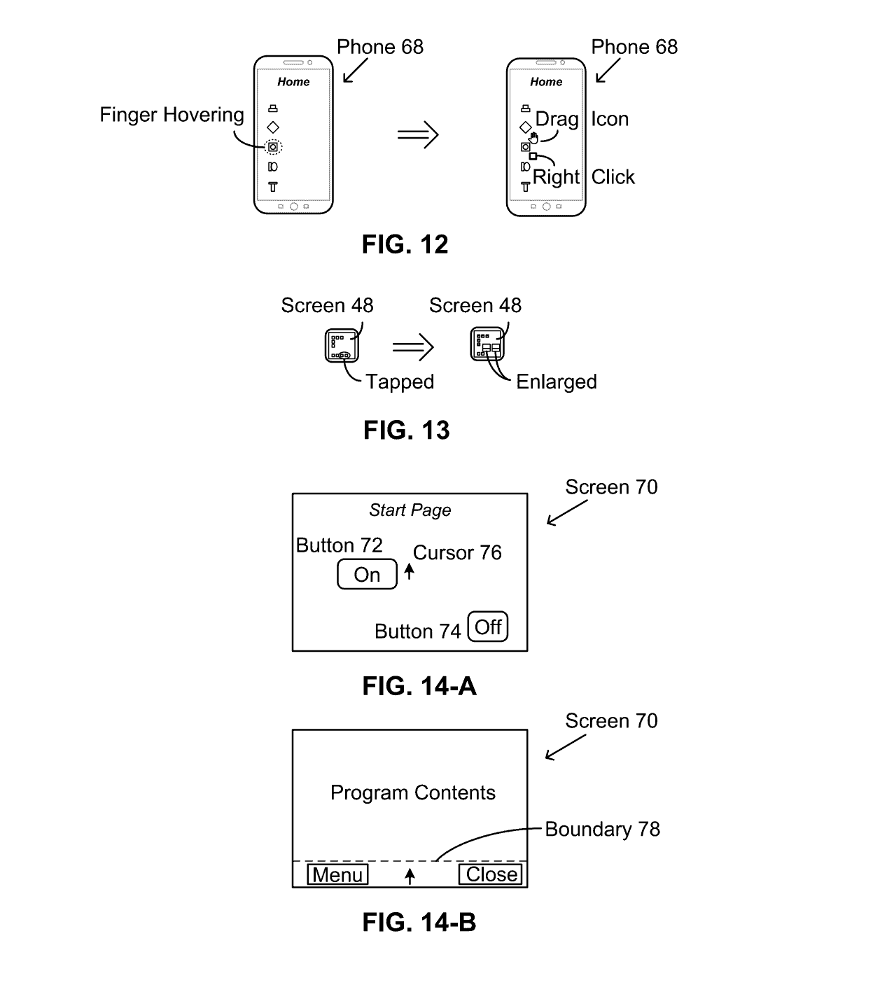

A smartphone application is illustrated graphically in FIG. 12. Assume a smartphone 68 has some objects configured on a touch screen. When a fingertip hovers over an object, two temporary icons may appear around the object for a given period of time. A hand-shaped icon on top of the object may be used to drag the object to places on screen. A rectangular icon below the object may enable right-click functionality. A user may relocate the object by keeping fingertip touching or pressing the hand-shaped icon and moving the fingertip on screen at the same time. After moving an object to a place, the user may lift the fingertip off the screen surface. Then, the object may stay there until being moved again. And a user may tap the rectangular icon to do right-click on the object, or tap the object itself for a left click.

In FIGS. 5-A and 5-B, gesture method is utilized to select small-sized object which may be hard to contact through tapping act since the objects are small and two or more neighboring objects may be engaged simultaneously by tap of fingertip. The situation has another solution. When two or more graphic objects are tapped together on a touch screen, because of small object size or other reasons, it may be designed that the tapped objects may appear with an enlarged size for a given short time, long enough for user to act, like considering and tapping, but not annoyingly too long. Hopefully, the new size of object may be big enough for adult fingertip to tap on individually. The process is depicted graphically using a small device in FIG. 13. Assume that two small objects are tapped simultaneously on screen 48 because they are too small in size and placed too close compared to the size of fingertip. With the new scheme, the two tapped objects may be enlarged, preferably big enough for individual selection using fingertip. Then the user may select and tap on one of them. It may also be designed that a user may have options to choose enlargement setting to fit personal need.

The tap-to-enlarge scheme applies to smartphones as well, when object size on phone screen becomes too small for fingertip to tap exclusively among multiple items. In addition to tapping, hovering may be used to deal with small objects, too. It may be designed that when a fingertip hovers over two or more objects on a touch screen, size of the two or more objects may be arranged to increase for a short given period of time. Then a user may pick one object to tap it. For instance, when a user prefers more folders and applications on screen, object size may be compromised and reduced to accommodate the need. Then the tap-to-enlarge or hover-to-enlarge schemes may be used if object size becomes a problem. The scheme applies to devices having a touch screen, and is especially useful for devices with a small screen.

Moreover, the schemes described in FIGS. 12 and 13 may be combined. When two or more objects on a touch screen are tapped or covered in a hovering act simultaneously, the two or more objects may be enlarged in size along with temporary icons arranged around each of them. Thus, tapping or hovering may not only increase the size of small objects, but also bring icons to enable additional functions such as right click and drag.

Furthermore, the combined enlarge-with-icons-by-tap-or-hover method may apply to screen objects with a normal size. It may be designed that when two or more objects are tapped on a touch screen, or a finger hovers over two or more objects on a touch screen, temporary icons may be arranged to show up around each involved object. Then a user may tap a selected item. The objects may have a normal size, and thus maybe no size enlargement is needed. Because extra icons take space, the selected objects may be allowed to have a larger area for a short time. The method brings convenience in some case. For instance, when a user wants to access one object, but accidently taps on two objects together, nothing may happen or a wrong object may be selected according to current settings. When the user realizes the mistake, he or she may have to re-do the process. With the new scheme, extra icons may emerge around the two objects. The user may proceed to tap a target object or icon, enjoying a smooth experience.

Besides smart phone, tablet computer, and wearable devices, gesturing methods as discussed in the above apply to television as well. Gesture input may complement a remote control device. Assume that a television is equipped with a gesture sensor like sensor 28 of FIG. 2. Also assume the sensor may be kept in operational mode whether the television is on or off, or the sensor may be switched on by certain user action. For instance, clapping may be used to turn on a gesture sensor. A user may clap hands to make a sound once or twice to trigger a gesture sensor, assuming that a sound sensor, which monitors audible signals, is in active mode. Or a gesture sensor may be switched on after a user gently knocks or pats on the television body, assuming a sound sensor or vibration sensor is already on. The above power-on schemes apply to a television in both on and off state. Alternatively, it may be designed that pushing an “On” button on television body at any time, whether a television is on or off, may trigger a gesture sensor, where it may be either a soft or hard button. For instance, after a user pushes an “On” button on a television set to turn it on, both the television and a gesture sensor may be waked up. Thus when a television begins showing programs, its gesture sensor may get started as well and stay in active mode for a given period of time. So in multiple ways, a user may turn on a gesture sensor of television conveniently.

After a gesture sensor is on, it may take images and recognize finger or hand gestures. Next, a user may request a gesture session, which has been introduced in the above. For instance, to start a gesture session, a user may keep a still hand in the air, stick one or more fingers out in the air, or wave hand or finger in front of a television for one or more times. As discussed before, an eye-tracking mechanism may be optionally incorporated to confirm the intention of user after receiving initial wakeup input and/or gesture signals, which may prevent inadvertent act or gestures from starting an unwanted event. At the beginning of gesture session, a cursor may appear on television screen along with some graphic objects representing control options. It may be designed that a cursor always appears around certain place initially, like a central, edge, or corner area of screen, for easy memory and easy sighting.

FIG. 14-A is an exemplary diagram illustrating an embodiment to turn on a television. Assume a gesture sensor is on or is turned on by user action and next the sensor senses an upright hand and starts a gesture input process. At first, a screen 70 is powered on after receiving the initial request from user. It may be designed that the screen displays a title “Start Page”, an “On” button 72, an “Off” button 74, and an arrow-shaped cursor 76. Cursor 76 may appear at the central area of screen and always show up in the area at the beginning of a session after the screen is turned on. Next, a user may move cursor 76 to overlap button 72 and use gesture-based click to activate the button, which may turn on the television system. If a user doesn't want to turn on the television, the user may “click” on button 74 using gestures. If no gesture input is received for a given period of time, the screen may turn off by itself automatically.

In FIG. 14-B, an embodiment is introduced graphically for controlling television in operational mode. Assume that when a television is showing a program, it receives signals to start gesture input session. Because screen 70 is showing program contents, anything introduced on screen should not affect the presentation to a certain degree. As in the figure, it may be designed that when a request to start gesture session is received during a television program, screen 70 may be split into two areas by a boundary line 78: A large area for continuing to show the program, and a small area for displaying a cursor and option buttons. The small area may be a narrow area at the bottom as depicted in the figure, or a narrow area along the left or right edge of the screen, or a small rectangular area at a corner. The small area may be designed to take less than one eighth of screen area to minimize impact on user experience. A cursor and one or multiple buttons may be configured in the small area. Again, a cursor may always emerge around the center of the small area. And a cursor may be limited to move around in the small area only. In the figure, an arrow represents cursor in the small area. The buttons may include a “Menu” button and a “Close” button. A “Menu” button may lead to a menu window or menu page, which may occupy a larger portion of screen than the small area when displayed. A “Close” button may be used to close the small area and terminate a gesture session. In addition, more buttons for functions frequently used may be added to the small area, such as “Last” button for switching to the last program or channel, “Power Off” button for turning off the television, button for enlarging the small area and showing more contents, or volume control button. A user may also have an option to avoid splitting the screen, if the user prefers to have cursor and buttons showing up in a screen view of ongoing program. For the convenience of user, a television screen grid may be object based, or objects on screen may have expanded boundaries. Like cases discussed, a temporary icon may appear to enable right click when an object is highlighted.

Besides “On” button, other buttons on a television body may also be arranged to wake up a gesture sensor, when the television is on. Moreover after a television is switched on, more buttons on a remote control device may be arranged to wake up a gesture sensor. It may be designed that when a button on a remote control is pressed, for instance, an “On” button when the television is off, or any other button except “Off” button when the television is on, a gesture sensor may be prompted to start working. The reason is that, aside from a user who has a remote control, other users on site may want to control the television too. A remote control device may provide a good chance to kick off a gesture session. After a user uses a remote control device to activate a gesture sensor, another user may gesture to request a session within a given time period. Next, a gesture input session may start and a screen view like FIG. 14-B may appear, since the television is already on. If a session request is not received after a given time period elapses, a gesture sensor may return to off state.

Voice recognition technology may be used to enhance gesture input method in addition to activating a gesture sensor as aforementioned. In particular, verbal command may be enlisted to do a “click” job, with the same effect as a click performed using a computer mouse or “click” by the finger bending method. For instance, it may be designed that after an object is highlighted by hovering or cursor overlapping, a user may say “Click” to the device to implement clicking act, which may activate the object, or launch a program associated with the object. A user may also say “Right click” to do a right-click job on a highlighted object. It is noticed that verbal method is especially suitable for small devices, like wearable devices and smart phones, since these devices may be at a place close to a user and thus well positioned to receive verbal commands from the user.

Two or more methods as discussed in the above may be combined when they are not in conflict. For instance, hover-to-highlight, hover-to-enlarge, and hover-to-gesture-session may be incorporated. It may be designed that, when a hovering event happens, object or objects may be highlighted, attached with temporary icons, and enlarged in size when necessary, and gesture session may get started. A user may either tap on touch screen, or make gestures in the air to give instructions. It may make interaction between device and user more user-friendly and more versatile. The combined schemes may apply to certain devices having a touch screen along with hovering detection capability and gesture input functionality.

Finger-bending as a click act is introduced in above sections. If a finger goes from straight to bent to straight state, it may generate a “click” action. Alternatively, if a user makes a finger move in the air so that the fingertip goes from one place to another place, and then back to the origin or original place within a given period of time, the finger movement may be designed as a “click” process, too. Since it may be inconvenient for a fingertip to return precisely to the original place for some users, it may also be designed such that a fingertip only needs to be back at a place relatively closer to the origin than a turnaround point for completing a “click” job. For instance, assume that the distance between an origin and turnaround point is of A. After traveling to the turnaround point, a fingertip may make a “click” act after it goes back to a place which may be anywhere between a middle point and the origin, or within a distance of half A from the origin. A middle point is located at the middle between an origin and a turnaround point. As it is the original, turnaround and final positions of fingertip that matter, whether a finger bends or not may become irrelevant. In other words, as long as a fingertip travels back and forth, every time it returns to the original place or get close to the original place, a click act may be considered accomplished, while the finger may keep straight or go through a bending process or the fingertip may travel in a straight line and/or curved line during the process. The duration of gesture-based click act has to be shorter than a certain value. If a finger goes to a place and stays there beyond a given time frame, it may be considered that the fingertip moves to a new place. Then even if the fingertip does get back to the origin, it may mean it is back only, and a click is not conducted.

When finger can be recognized, finger gesture may be used to do click and other tasks. In some cases, fingertip may be selected as an observation spot for gesture detection. Alternatively, other part of hand or hand itself may be selected as an observation spot too. For instance, any moving part of user hand may be chosen and followed in a monitoring process. Once a user hand is recognized, gesture sensor may be arranged to detect what part of the hand is moving and how it moves. A moving part may be one or more fingers, or the hand itself. A hand may have spread fingers or other gestures like a fist with palm facing any direction, as long as it can be recognized as a hand. When finger movement is observed while the hand remains relatively stable, a fingertip or another part of the finger may be selected as an observation spot and monitored. When the whole hand moves, any part of the hand which remains visible may be chosen as an observation spot and monitored. When finger image is fuzzy due to sensor resolution or large distance between finger and sensor, hand image may become the only target to detect and monitor, serving as observation spot. In addition, hand orientation may become irrelevant, or user's palm may face any direction, as long as user hand can be detected. When hand movement is observed, center or any spot of hand image may be chosen for observation and be monitored. For instance, when a user moves hand for one place to another place, a cursor may moves on screen accordingly, as directed by the trajectory of observation spot of user hand. When it is detected that a hand does a back-and-forth act, like moving to a place in the air and then getting back to a place around the origin within a given time period, say two or three seconds or less, it may be determined that a click act is performed.

Furthermore, for click act, it may be designed that outgoing and returning paths may be similar, like a back-and-forth act, or may be different. In the latter case, trajectory of observation spot may create a circle-like pattern. Both above clicking cases share the same feature, i.e., an observation spot moves away from a first place after staying there for at least a given time period, travels to the farthest place (relative to the first place), then arrives at a second place, and stays at the second place for at least a given time, while the second place is closer to the first place than the farthest place. Such a general definition for click act, as one option for users, may apply to all gesture cases when clicking is performed, if it doesn't interfere with other rules or arrangements. Thus, when a user is close to a device and finger image is clear, both finger and hand gesture may play a major role. When finger image isn't clear enough, hand movement may be observed and hand trajectory may be monitored to obtain user instructions. With the general click definition, finger or hand waving and circling, and other back-and-forth movements may all be used to do click act. Thus a user may choose one from several options to perform click act, making gesture-based click easy to do and more user-friendly.

Hovering act in hover-to-gesture-session scheme as discussed in the above may be replaced by tapping on a touch screen with the same outcome. For instance, when a user taps on a touch screen, it may be configured to turn on a gesture sensor and start a gesture session besides implementing a tapping act. Assume a user taps on an object which is an icon of a folder. Next a window of the folder may pop up, and an arrow as cursor may appear at the place where tapping happens. The arrow may mean start of a gesture session. When it is detected that a fingertip, which just tapped on screen a short while ago, moves in the air, the arrow may be designed to move on screen accordingly. When a fingertip moves in a direction vertical to the screen surface, the arrow may remain at the same place; when the fingertip moves along other directions, the arrow may move along accordingly and proportionally. It is noted that at the beginning, a user may have to lift the fingertip away from the screen surface and into the gesture sensor's field of view so that it may be detected. It may be designed that once a fingertip leaves a place which is close to screen surface or on the surface and enters gesture sensor's field of view, its position in the air may correspond to a screen spot where tapping happened or finger hovered over. Thus when a user lifts fingertip off a screen to engage in a gesture session, the fingertip better goes along a direction vertical to the screen surface, which may make position of fingertip in the air match cursor position on screen. Like hovering method, a tap-to-gesture-session scheme may bring convenience and flexibility to users by providing additional input options. During a gesture session, an “Off” button may be arranged on screen which, when tapped, may end a gesture session and turn off a gesture sensor.

After a gesture sensor wakes up from a dormant mode, it may be arranged to remain active for a predetermined period of time. If session request signal is not detected during the period of time, the gesture sensor may go back to inactive state or turn off automatically.

After a gesture session starts, it may remain on for a given period of time. But if further gesture input is not received during the given period of time, the session may stop automatically. The rule applies to any time during a gesture input process.

With schemes like tap-to-gesture-session and hover-to-gesture-session, a gesture sensor may be kept in active mode for a long time, when a user taps on screen or does hovering act frequently. Since a gesture sensor may take picture or video constantly, it may become a nuisance for some users due to energy consumption and privacy concerns. Thus a switch may be designed so that a user may have an option to turn the function on or off. For instance, if a user wants to have more input means available, the user may like prolonged period of gesture session as a result of active tapping or hovering act. If a user doesn't like to have gesture mode when doing tapping, he or she may turn off the function, which may be turned on again anytime when needed. A gesture-session on/off button may be configured to be with other on/off buttons in a setup section.

Besides using eye-tracking method to detect whether a user gazes at a direction towards a device, certain less accurate techniques may be enlisted to verify user's intention too. For instance, user's face or upper body may also give a signal. It may be designed that when one eye, one ear, or one arm becomes invisible, gesture input from user may be ignored.

After a gesture sensor wakes up from sleep mode or is turned on from off mode, the sensor may be arranged to acquire user images. Next, the images are analyzed to recognize user finger, hand, head, and body. For some gesture sessions, getting consecutive images of user finger and hand may be enough. Finger and hand movement may be analyzed and translated into user commands. When finger image is fuzzy and can't be used to figure out finger act, image of hand is observed and used for gesture input. When eye-tracking method is involved in a gesture session, image of user head and face are taken and image of eye is analyzed to confirm user intention. Additionally, as discussed, ear and arm images may also be taken and used to ascertain whether a user pays attention to a presenting device.

Lastly, besides optical imaging method which captures video signals of gestures, gesture input may also be detected by ultrasonic technology, radio-frequency technology, infrared technology, or other suitable technologies.

Therefore the scope of the invention should be determined by the appended claims and their legal equivalents, rather than by the examples given.

1. A system having a display and stored executable instructions, comprising:
1) a gesture sensor for getting gesture info of user and monitoring hand and/or finger movement within a given period of time;
2) a display for showing a plurality of graphic objects;
3) a control program for displaying a cursor on said display and changing position of said cursor according to said gesture info and monitoring results; and
4) said system arranged such that position of said cursor is always related to position of one of said plurality of graphic objects.

2. The system according to claim 1 wherein position of said cursor is related to position of two of said plurality of graphic objects.

3. The system according to claim 1 wherein one or two grid lines are added to a grid configuration automatically after a new graphic object is arranged to appear on said display.

4. The system according to claim 1, further including a grid program which provides options to show or hide grid lines.

5. A method for displaying a cursor on a screen, comprising:
1) operating a gesture sensor for getting gesture info of user and monitoring hand and/or finger movement within a given period of time;
2) displaying a plurality of graphic objects on said screen;
3) displaying a cursor on said screen;
4) changing position of said cursor on said screen according to said gesture info and monitoring results; and
5) said method arranged such that position of said cursor is always related to position of one of said plurality of graphic objects.

6. The method according to claim 5 wherein position of said cursor is related to position of two of said plurality of graphic objects.

7. The method according to claim 5, further including adding one or two grid lines to a grid configuration after a new graphic object is arranged to appear on said display.

8. A method for highlighting a graphic object on a screen, comprising:
1) displaying a plurality of graphic objects on said screen;
2) displaying a cursor on said screen;
3) monitoring position of said cursor and monitoring whether said cursor enters an effective area of one of said plurality of graphic objects;
4) highlighting said one of said plurality of graphic objects after it is determined that said cursor enters said effective area; and
5) size of said effective area arranged to be adjustable by user.

9. The method according to claim 8, further including enlarging said effective area automatically after a gesture input session begins.

10. The method according to claim 8, further including expanding effective areas of said plurality of graphic objects respectively such that the effective areas fill entire space of said screen.
